(19) United States
(12) Patent Application Publication
(10) Pub. No.: US 2011/0250499 A1
(43) Pub. Date: Oct. 13, 2011

(54) POSITIVE ELECTRODE ACTIVE MATERIAL FOR LITHIUM ION SECONDARY BATTERY, METHOD FOR PRODUCING THE SAME, AND LITHIUM ION SECONDARY BATTERY

(76) Inventor: Hidekazu Hiratsuka, Osaka (JP)

(21) Appl. No.: 13/129,324

(22) PCT Filed: Mar. 31, 2010
(86) PCT No.: PCT/JP2010/002389

§ 371 Date: May 13, 2011

(30) Foreign Application Priority Data
Apr. 3, 2009 (JP) 2009-091066

(51) Int. Cl. H01M 4/525; H01M 4/04

(52) U.S. Cl. 429/223; 252/182.1

(57) ABSTRACT

Disclosed is a positive electrode active material for a lithium ion secondary battery, including lithium composite oxide particles containing nickel, manganese and cobalt, the lithium composite oxide particles being a layered compound having a hexagonal crystal structure, and exhibiting a powder X-ray diffraction pattern obtained by using CuKα radiation at 25° C. in which a maximum peak within a range of 2θ=44° to 45° is present at 2θ=44.4° to 45°. Also disclosed is a lithium ion secondary battery including: a positive electrode including a positive electrode active material capable of absorbing and desorbing lithium ions; a negative electrode including a negative electrode active material capable of absorbing and desorbing lithium ions; a separator interposed between the positive electrode and the negative electrode; and a non-aqueous electrolyte, wherein the positive electrode active material is the above positive electrode active material for a lithium ion secondary battery.

### TECHNICAL FIELD

The present invention relates to a positive electrode active material for a lithium ion secondary battery, a method for producing the same, and a lithium ion secondary battery. Specifically, the present invention relates to an improvement of a positive electrode active material for a lithium ion secondary battery.

### BACKGROUND ART

In recent years, consumer electronic devices are rapidly becoming portable and cordless, and there is an increasing demand for small-sized and light-weighted secondary batteries with high energy density for use as a power source for these electronic devices. With regard to such secondary batteries, lithium ion secondary batteries are particularly attracting attention as batteries with high capacity and high energy density.

A typical positive electrode active material used for lithium ion secondary batteries is lithium cobalt oxide (LiCoO₂). Further, a lithium composite oxide containing three elements, nickel, manganese and cobalt, is also known as a positive electrode active material having an energy density higher than that of LiCoO₂.

The followings are known as examples of the lithium composite oxide containing three elements, nickel, manganese and cobalt.

For example, Patent Literature 1 below discloses a lithium-rich composite oxide in which the stoichiometric composition of a transition metal oxide having a layered structure, LiMeO₂ (Me: transition metal element) is intentionally changed, and part of the transition metal element forming layers is replaced with lithium ions. Further, for example, Patent Literature 2 below discloses a lithium composite oxide containing nickel and manganese in an equimolar ratio. Furthermore, for example, Non-patent Literature 1 below discloses a lithium composite oxide containing nickel, manganese and cobalt in an equimolar ratio and being represented by the compositional formula: LiCO_{1/3}Ni_{1/3}Mn_{1/3}O₂.

However, expected energy densities of the lithium composite oxides disclosed in Patent Literatures 1 and 2 and Non-patent Literature 1 are almost at the same level of that of the conventionally-used LiCoO₂. The reason for this is as follows: these lithium composite oxides have a large reversible capacity; however, the charge and discharge potentials drop as the charge/discharge cycles proceed, which results in the same level of energy density as that of the conventionally-used LiCoO₂.

As such, in order to obtain a battery having a capacity higher than the conventional LiCoO₂ battery by using a lithium composite oxide as disclosed in Patent Literatures 1 and 2 and Non-patent Literature 1, the charge voltage needs to be increased from the conventional 4.2 V to 4.4 V or higher. Increasing the charge voltage may in turn pose a new problem that will cause the reliability of the battery to degrade, such as gas generation and leaching of metal ions.

In addition, a LiNiO₂-based lithium composite oxide with high nickel element content is proposed as a lithium composite oxide with which a much higher capacity of a lithium ion secondary battery can be expected. Specifically, for example, Patent Literature 3 below discloses a lithium composite oxide represented by the compositional formula: LiNi_{1-x-z}CoₓAl_{z}O₂ in which about 10% (by element ratio) of nickel is replaced with cobalt and is further doped with aluminum. The replacement of nickel with cobalt suppresses complicated changes in crystal structure of LiNiO₂ associated with charging and discharging, and the doping with aluminum ensures a thermal structural stability during charging.

The material disclosed in Patent Literature 3 is expected to have a high energy density which is about 20% higher than that of LiCoO₂, even when the charge voltage is 4.2 V. However, this material has a problem in that its layered structure tends to become unstable due to considerable deintercalation of Li therefrom during charging, and the structural stability thereof during charging is low. Moreover, this material releases oxygen at a comparatively low temperature to allow the thermally unstable tetravalent nickel to be reduced to nickel having a valence of two or less, which may cause the reliability and safety of the battery to be deteriorated.

### CITATION LIST

### Patent Literature

[PTL 1] Japanese Laid-Open Patent Publication No. 2002-110167
[PTL 2] Japanese Laid-Open Patent Publication No. 2004-528691
[PTL 3] Japanese Laid-Open Patent Publication No. Hei 9-237631

### Non-patent Literature

[NPL 1] T. Ohzuku and Y. Makimura, Chem. Lett., 642 (2001).

### SUMMARY OF INVENTION

### Technical Problem

The present invention intends to provide a positive electrode active material for providing a lithium ion secondary battery having a high energy density and excellent cycle characteristics, and a method for producing the same, and to provide a lithium ion secondary battery including the positive electrode active material.

### Solution to Problem

A positive electrode active material for a lithium ion secondary battery of the present invention comprises a layered compound containing nickel, manganese and cobalt, having a hexagonal crystal structure, and exhibiting a powder X-ray diffraction pattern obtained by using CuKα radiation at 25° C. in which a maximum peak within the range of 2θ=44° to 45° is present at 2θ=44.4° to 45°.

A lithium ion secondary battery of the present invention comprises a positive electrode including a positive electrode active material capable of absorbing and desorbing lithium ions; a negative electrode including a negative electrode active material capable of absorbing and desorbing lithium ions; a separator interposed between the positive electrode and the negative electrode; and a non-aqueous electrolyte, wherein the positive electrode active material in an uncharged state comprises lithium composite oxide particles containing nickel, manganese and cobalt, the lithium composite oxide particles being a layered compound having a hexagonal crystal structure, and exhibiting a powder X-ray diffraction pattern obtained by using CuKα radiation at 25° C. in which a maximum peak within the range of 2θ=44° to 45° is present at 2θ=44.4° to 45°.

A method for producing a positive electrode active material for a lithium ion secondary battery of the present invention comprises a first step of baking particles of a mixture while being caused to flow, at a temperature within the range of 720° C. to 900° C., the mixture comprising lithium carbonate or lithium hydroxide, and a nickel-manganese-cobalt compound having a composition represented by the general formula (II):

(Ni_{1-y-z}Mn_{y}CO_{z}) (OH)₂ (II)

where y and z satisfy 0.15≦y≦0.3, 0.05≦z≦0.3, 0.2≦y+z≦0.6; and a second step of further baking a baked material obtained in the first step at a temperature within the range of 750° C. to 1000° C.

### ADVANTAGEOUS EFFECTS OF INVENTION

According to the present invention, it is possible to provide a lithium ion secondary battery having a high energy density and excellent cycle characteristics.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 A longitudinal cross-sectional view schematically showing the configuration of a production apparatus used in a method for producing a positive electrode active material for a lithium ion secondary battery according to one embodiment of the present invention.

FIG. 2 A graph showing the relationship between a peak angle corresponding to the (104) plane within the range of 2θ=44° to 45° in a powder X-ray diffraction pattern of the positive electrode active material for a lithium ion secondary battery, and a capacity density thereof.

FIG. 3 A longitudinal cross-sectional view schematically showing the configuration of a lithium ion secondary battery according to one embodiment of the present invention.

### DESCRIPTION OF EMBODIMENTS

The present inventor conducted intensive studies to solve the problems in the conventional techniques, and as a result, found that a lithium composite oxide containing three elements, nickel, manganese and cobalt, and having a specific crystal structure is excellent in structural stability, particularly the structural stability during charging and discharging at high temperatures. Further, a lithium ion secondary battery using such a lithium composite oxide as a positive electrode active material has a high energy density and excellent cycle characteristics.

In producing a lithium composite oxide of this embodiment, it is important to suppress the occurrence of crystal distortion. Crystal distortion occurs when the chemical bonds in the crystal become unstable due to uneven capture of oxygen into the crystal or due to oxygen deficiency. If crystal distortion occurs, the structural stability of the lithium composite oxide will be lowered. In particular, the crystal structure of the lithium composite oxide from which lithium ions have been released during charging will become unstable, and the cycle characteristics of the battery will be deteriorated.

In addition, it is also important to suppress the occurrence of disorder, that is, replacement of some lithium ions with nickel ions. If disorder occurs, nickel ions will be co-present in the sites which otherwise would have been occupied by lithium ions. This prevents the movement of lithium ions associated with charging and discharging, and the lithium composite oxide may fail to fully exert its capacity.

Firstly, a method for producing a positive electrode active material for a lithium ion secondary battery of this embodiment is described.

The production method of this embodiment includes: a first step of baking particles of a mixture while being caused to flow, at a temperature within the range of 720° C. to 900° C., the mixture comprising a nickel-manganese-cobalt compound having a composition represented by the above general formula (II), and lithium carbonate or lithium hydroxide; and a second step of further baking a baked material obtained in the first step at a temperature within the range of 750° C. to 1000° C.

In the first step, particles of a mixture are prepared as a raw material, the mixture comprising a nickel-manganese-cobalt compound having a composition represented by the above general formula (II) (a precursor), and lithium carbonate or lithium hydroxide, and subsequently, the prepared mixture is baked at a temperature within the range of 720° C. to 900° C.

The nickel-manganese-cobalt compound having a composition represented by the above general formula (II) (the precursor) is prepared by, for example, as follows.

In order to allow the baking reaction in the first step to proceed uniformly, the nickel-manganese-cobalt compound having a composition represented by the above general formula (II) is preferably a coprecipitated material in which nickel, manganese and cobalt are dispersed at molecular level. Such a coprecipitated material is prepared as a particulate precursor, by adding an alkali aqueous solution dropwise to an acidic aqueous solution containing nickel ions, manganese ions and cobalt ions.

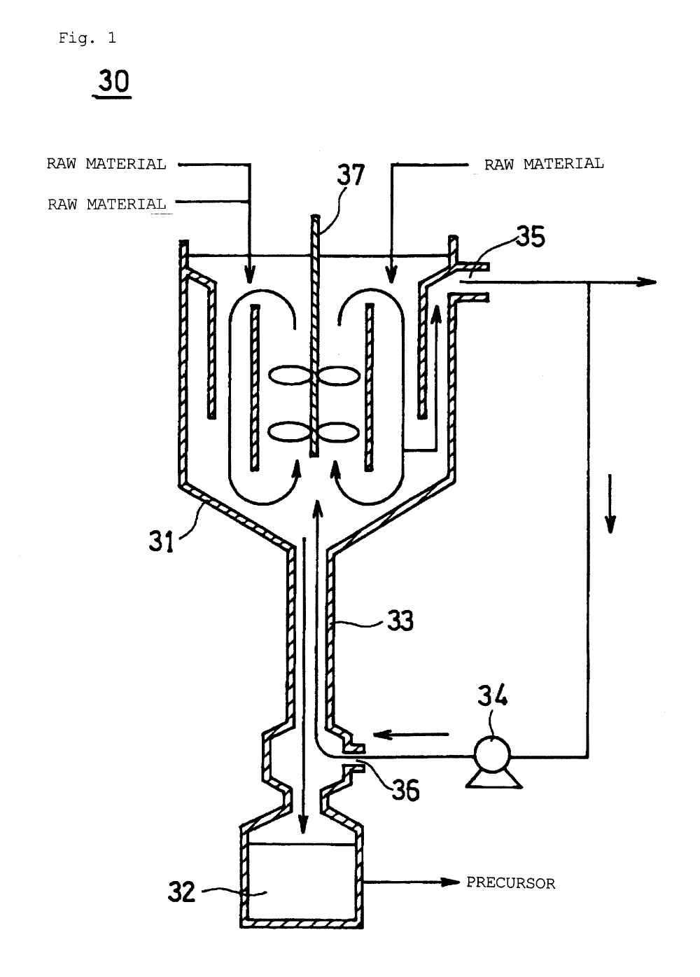

It should be noted that a precursor prepared through rapid coprecipitation reaction is not only small in particle size but also low in tap density. A lithium composite oxide prepared from such a precursor is not suitable as a positive electrode active material. Therefore, in order to obtain a precursor having a large particle size and high tap density, it is preferable to use, for example, a production apparatus as shown in FIG. 1.

FIG. 1 is a longitudinal cross-sectional view schematically showing the configuration of a production apparatus 30 used in the method for producing a positive electrode active material for a lithium ion secondary battery according to this embodiment. The production apparatus 30 is equipped with a reaction vessel 31, a collector vessel 32, a pipe 33, a pump 34, an overflow port 35, a return port 36, and a stirrer 37.

In the reaction vessel 31, for example, an acidic aqueous solution including nickel sulfate, manganese sulfate and cobalt sulfate is stored, to which an alkali aqueous solution is added dropwise, to allow coprecipitation reaction to proceed. The collector vessel 32 is disposed vertically below the reaction vessel 31 and is communicated with the bottom of the reaction vessel 31 through the pipe 33. The side wall of the reaction vessel 31 is provided with the overflow port 35. The pump 34 is provided for transferring mixture solution in the reaction vessel 31 overflown from the overflow port 35, if any, to the return port 36 formed on the pipe 33.

In the operation using the production apparatus 30, firstly, an aqueous nickel sulfate solution, an aqueous manganese sulfate solution, and an aqueous cobalt sulfate solution are fed as raw materials from the top of the reaction vessel 31. These solutions may be fed separately, or fed together. The mixture of these solutions is an acidic aqueous solution of this embodiment.

The aqueous nickel sulfate solution, the aqueous manganese sulfate solution, and the aqueous cobalt sulfate solution are fed into the reaction vessel 31 while the stirrer 37 in the reaction vessel 31 is being rotated. These aqueous solutions are fed in such amounts that they almost fill the reaction vessel 31. In such a manner, a mixture solution used as an acidic aqueous solution is prepared in the reaction vessel 31, and the acidic aqueous solution is homogenized. This acidic aqueous solution is fed also to the pipe 33 disposed under the reaction vessel 31. The acidic aqueous solution overflown from the overflow port 35 of the reaction vessel 31 is transferred via the pump 34, and returned from the return port 36 into the reaction vessel 31. In such a manner, a flow of the acidic aqueous solution moving upward from the bottom of the reaction vessel 31 is created.

The salt concentrations in the aqueous nickel sulfate solution, aqueous manganese sulfate solution, and aqueous cobalt sulfate solution to be fed into the reaction vessel 31 are not particularly limited. Specifically, for example, it is preferable to use an aqueous nickel sulfate solution, an aqueous manganese sulfate solution, and an aqueous cobalt sulfate solution each having a salt concentration of 1.1 mol/L to 1.3 mol/L, and more preferably 1.2 mol/L, in view of achieving excellent uniform dispersibility of the three elements in a resultant precursor, good progress of coprecipitation reaction and the like.

The amounts of the aqueous nickel sulfate solution, aqueous manganese sulfate solution, and aqueous cobalt sulfate solution to be fed into the reaction vessel 31 are not particularly limited, and are selected as appropriate according to the composition of a lithium composite oxide to be finally obtained, but it is desirable to control the total amount such that the feeding rate becomes preferably 1 mL/min to 2 mL/min, and more preferably 1.5 mL/min. It should be noted that the values y and z in the general formula (II) can be adjusted by, for example, changing the salt concentrations in the aqueous nickel sulfate solution, aqueous manganese sulfate solution, and aqueous cobalt sulfate solution, or the ratio of these aqueous solutions to be used.

In preparing the precursor by coprecipitation method, preferably, the nickel, manganese and cobalt elements are each in a bivalent state forming Me(OH)₂ (Me: nickel, manganese and cobalt) and are uniformly dispersed in the particles (the precursor). Among these elements, manganese is very susceptible to oxidation, and therefore, if dissolved oxygen is present even in a small amount in the acidic aqueous solution, tends to be oxidized to trivalent manganese ions.

The trivalent manganese ions are present as MnOOH in the particles (the precursor). In this case, uniform dispersion in the particles is inhibited. In other words, Ni(OH)₂, Co(OH)₂ and Mn(OH)₂, because of their analogous crystal structures, allow the three elements to be uniformly dispersed at nano-scale level in the precursor; however, MnOOH, which has a different crystal structure, makes the uniform dispersion difficult.

Therefore, in order to suppress the formation of trivalent manganese ions, it is preferable to force out the dissolved oxygen by bubbling of an inert gas such as nitrogen gas or argon gas into the acidic aqueous solution, or to add a reducing agent such as an ascorbic acid beforehand into the acidic aqueous solution.

After the flow of the acidic aqueous solution has been created in the reaction vessel 31 as described above, an alkali aqueous solution, which is another raw material, is added dropwise into the reaction vessel 31 from the top thereof while the acidic aqueous solution stored in the reaction vessel 31 is being stirred with the stirrer 37. This allows the formation of coprecipitation nuclei in the acidic aqueous solution. The coprecipitation nuclei fall toward the bottom of the reaction vessel 31, but when collide with the flow of the acidic aqueous solution moving upward from the bottom of the reaction vessel 31, are moved back toward the top of the reaction vessel 31. The crystal nuclei of the coprecipitation nuclei grow through this movement, but while the specific gravity thereof is not increased to a certain level, the coprecipitation nuclei stay in the reaction vessel 31. Upon reaching the certain level of specific gravity, the coprecipitation nuclei fall and deposit in the collector vessel 32.

Examples of the alkali aqueous solution include an aqueous NaOH solution and an aqueous ammonia solution. The alkali concentration in the alkali aqueous solution is not particularly limited, but is preferably 4.5 mol/L to 5.0 mol/L, and more preferably 4.8 mol/L, in view of achieving excellent uniform dispersibility of the three elements in a resultant precursor, good progress of coprecipitation reaction and the like. The feeding amount of the alkali aqueous solution is not particularly limited, but is preferably controlled such that the feeding rate becomes preferably, for example, 0.1 mL/min to 1 mL/min, and more preferably 0.5 mL/min.

The collector vessel 32 is disposed at a position below the return port 36. As such, only the coprecipitated material having grown to a certain size to have an increased specific gravity falls without being pushed back by the force of the flow of the acidic aqueous solution and enters the collector vessel 32. The use of the production apparatus 30 as described above makes it possible to prepare a precursor having a particle size as large as 10 μm to 20 μm and a tap density of 2.2 g/cm³ or more, as a composite hydroxide or a composite oxide.

Subsequently, the resultant precursor is mixed with lithium carbonate or lithium hydroxide, and the resultant mixture is baked while being caused to flow, at a temperature within the range of 720° C. to 900° C. More specifically, while the resultant mixture is being caused to flow, the temperature is raised to 720° C. to 900° C., and the resultant mixture is then baked at a temperature within the range of 720° C. to 900° C. or preferably of 750° C. to 850° C. This gives a baked material with less crystal distortion serving as a precursor of a lithium composite oxide.

In the process of raising the temperature, lithium carbonate or lithium hydroxide melts at 450° C. to 650° C., and, while capturing oxygen, penetrates into the nickel-manganese-cobalt compound particles. Synthesis reaction occurs at 650 to 710° C., and a lithium composite oxide is formed. Here, uniform progress of the synthesis reaction can be achieved by raising the temperature to 720 to 900° C. while causing the mixture to flow. This reduces the crystal distortion, forms stable chemical bonds in the crystal, and gives a lithium composite oxide having a high structural stability.

If the mixture is heated without being caused to flow, the structural stability of a resultant lithium composite oxide is lowered because the crystal distortion is increased and the stability of the chemical bonds in the crystal is lowered.

Lithium carbonate and lithium hydroxide as used herein have an advantage in that they are less expensive and emit less amounts of environmental pollution gases such as NOₓ and SOₓ when baked, than lithium nitrate and lithium sulfate which have been conventionally used as raw materials of a lithium composite oxide.

The baking in the first step is usually performed by using a baking kiln. Any baking kiln may be used here without particular limitation, but, in view of the mass productivity and others, preferred is a continuous-type rotary kiln equipped with a mechanism capable of continuously feeding and continuously ejecting the baked material.

The baking in the first step is usually performed at a temperature within the range of 720° C. to 900° C. as described above. When the baking temperature is below 720° C., there is a possibility that the whole mixture is not heated uniformly, and it takes longer time for part of the mixture to reach a temperature at which the synthesis of a lithium composite oxide starts, causing the baking time to be prolonged. This may results in a reduced production efficiently. On the other hand, when the baking temperature is over 900° C., the baking kiln may corrode easily, impairing the durability of the baking kiln.

By setting the baking temperature within the foregoing preferable range of 750° C. to 850° C., the production efficiency is further improved, and the corrosion resistance and the durability of the baking kiln are also further improved.

The rotation rate of the rotary kiln is not particularly limited, and is selected as appropriate according to the ratio of the precursor to the lithium hydroxide or lithium carbonate in the mixture of these, the composition of the precursor, the feeding amount and feeding rate of the mixture into the rotary kiln, the internal structure of the rotary kiln, and other factors, but is preferably set at 1 rpm/min to 10 rpm/min, and more preferably set at 1 rpm/min to 3 rpm/min.

In the second step, the baked material obtained in the first step is further baked, to allow sintering to proceed until desired powder properties are obtained. However, if the baking temperature is too high, oxygen is released from the crystal, and the crystal structure may be disordered. In order to prevent the occurrence of such disorder in the crystal structure, it is preferable to control the baking temperature such that the difference Δ2θ between an angle of the maximum peak within the range of 2θ=44° to 45° in a powder X-ray diffraction pattern obtained by using CuKα radiation at 25° C. of the baked material obtained in the first step and an angle of the maximum peak within the range of 2θ=44° to 45° in a powder X-ray diffraction pattern obtained by using CuKα radiation at 25° C. of the baked material obtained in the second step becomes 0.03 or less. It is more preferable to control such that the difference Δ2θ becomes 0.02 or less.

The baking temperature for achieving the difference of 0.03 or less is varied depending on the crystal structure, composition or the like of the baked material obtained in the first step, but is 720° C. to 900° C. and preferably 750° C. to 850° C. By performing re-baking at such a baking temperature, the lithium composite oxide of this embodiment can be obtained.

The baking in the second step is usually performed by using a baking kiln. Any baking kiln may be used here without particular limitation, and either type of baking kiln may be used: a continuous-type baking kiln or a batch-type baking kiln.

The positive electrode active material of this embodiment thus obtained is a layered lithium composite oxide containing nickel, manganese and cobalt together with lithium and having a hexagonal crystal structure, and is characterized by exhibiting a powder X-ray diffraction pattern obtained by using CuKα radiation at 25° C. in which the maximum peak within the range of 2θ=44° to 45° is present at 2θ=44.4° to 45°.

Specifically, in the powder X-ray diffraction pattern obtained by using CuKα radiation at 25° C. of the positive electrode active material of this embodiment, the angle of diffraction peak corresponding to the (104) plane within the range 2θ=44° to 45° is present at 44.4° or more and preferably 44.4° to 45°.

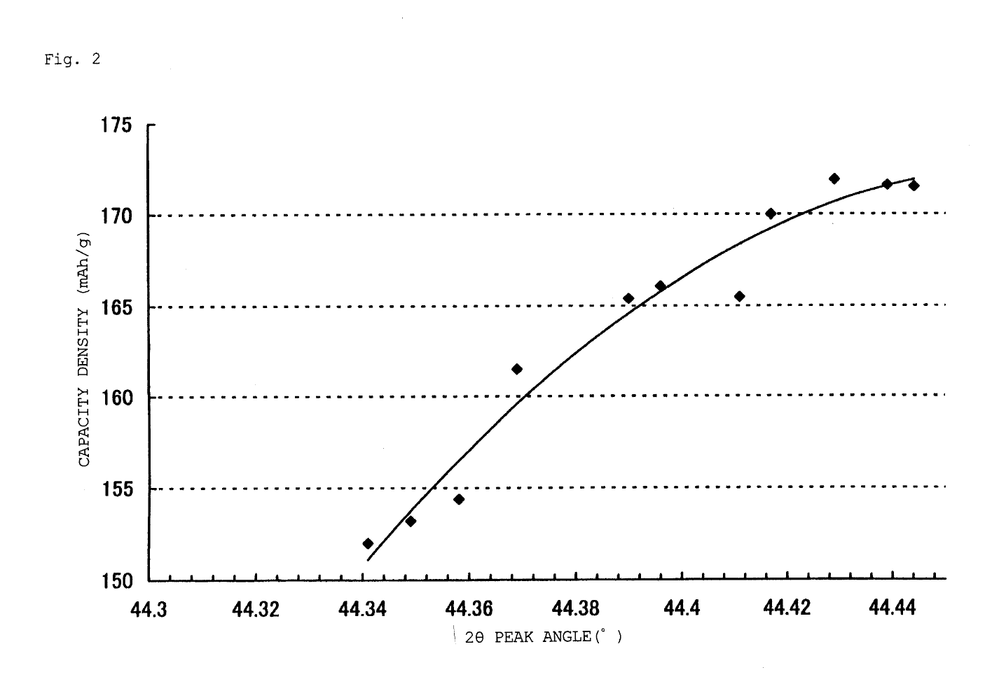

FIG. 2 is a graph showing the relationship between an angle of diffraction peak corresponding to the (104) plane within the range of 2θ=44° to 45° in a powder X-ray diffraction pattern of a lithium composite oxide containing three elements, nickel, manganese and cobalt, and a capacity density thereof. It should be noted that the relationship shown in the graph of FIG. 2 is measured by using a 2016 coin battery (diameter: 20 mm, thickness: 1.6 mm). The “2θ peak angle” plotted on the horizontal axis is an angle of diffraction peak corresponding to the (104) plane within the range of 2θ=44° to 45°.

Research by the present inventor has revealed that when the angle of diffraction peak corresponding to the (104) plane within the range of 2θ=44° to 45° of a lithium composite oxide is present at 44.4° or more, not only the capacity and energy density of the lithium composite oxide are improved as shown in FIG. 2, but also the structural stability of the crystal, particularly the structural stability during charging and discharging at high temperatures, is considerably enhanced.

By using the foregoing lithium composite oxide as a positive electrode active material, it is possible to suppress the occurrence of gas generation due to decomposition of the non-aqueous electrolyte, leaching out of metal ions from the positive electrode, and the like. Therefore, the use of the foregoing lithium composite oxide can provide a lithium ion secondary battery having a high capacity and a high energy density, having excellent charge/discharge characteristics and cycle characteristics, and being highly safe and reliable. It is not sufficiently clear why the lithium composite oxide of this embodiment has such excellent effects as above, but it is presumably because the lithium composite oxide of this embodiment is produced such that the occurrence of distortion or disorder in the crystal structure is suppressed.

When the angle of diffraction peak corresponding to the (104) plane within the range of 2θ=44° to 45° is present at less than 44.4°, the capacity and energy density are reduced as shown in FIG. 2, and the crystal distortion is increased, which may lower the structural stability. Consequently, the charge/discharge characteristics and cycle characteristics of the battery are deteriorated, and the safety and reliability of the battery are impaired.

The lithium composite oxide of this embodiment preferably has a composition represented by the general formula (I) below:

Li₁₊ₓ(Ni_{1-y-z}Mn_{y}CO_{z})₁₋ₓO₂ (I)

where x, y and z satisfy −0.05≦x≦0.10, 0.15≦y≦0.3, 0.05≦z≦0.3, and 0.2≦y+z≦0.6.

In a lithium composite oxide having such a composition, the structural stability of the crystal is further improved, and, for example, lithium ions can be absorbed thereto or desorbed therefrom without accompanying irreversible changes in the crystal structure not only in the room temperature region but also in the high temperature region of about 40° C. to 90° C. As a result, the charge/discharge characteristics and cycle characteristics of the battery are further improved, and the reduction in the capacity retention rate becomes very small even when charge/discharge cycles are repeated over a long period of time.

In the above general formula (I), “y+z” is further preferably within the range of 0.3 to 0.5, in view of the structural stability of the crystal.

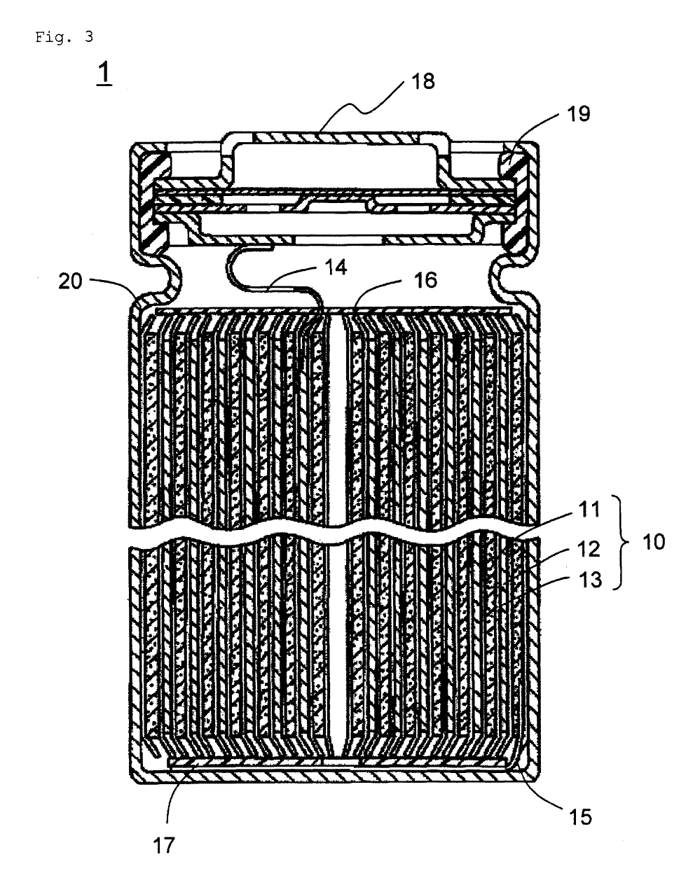

FIG. 3 is a longitudinal cross-sectional view schematically showing the configuration of a lithium ion secondary battery 1 according to this embodiment. The lithium ion secondary battery 1 (hereinafter simply referred to as a “battery 1”) is a cylindrical battery characterized by including the above-described positive electrode active material as a positive electrode active material.

The battery 1 includes a wound electrode assembly 10 obtained by winding a positive electrode 11 and a negative electrode 12 with a separator 13 interposed therebetween (hereinafter simply referred to as an “electrode assembly 10”), a positive electrode lead 14 connecting a positive electrode current collector plate of the positive electrode 11 with a sealing plate 18 serving as a positive terminal, a negative electrode lead 15 connecting a negative electrode current collector of the negative electrode 12 with a battery case 20 serving as a negative terminal, an upper insulating plate 16 and a lower insulating plate 17 providing electrical insulation to the electrode assembly 10, the sealing plate 18 sealing the opening of the battery case 20 and also functioning as the positive terminal, a gasket 19 interposed between the sealing plate 18 and the battery case 20 and providing electrical insulation therebetween, and the battery case 20 having a bottomed cylindrical shape and accommodating the electrode assembly 10, a non-aqueous electrolyte (not shown) and the like.

In fabricating the battery 1, first, the positive electrode lead 14 and the negative electrode lead 15 are each welded at a predetermined position, and the upper insulating plate 16 and the lower insulating plate 17 are placed on the both ends of the electrode assembly 10 in the longitudinal direction thereof. Next, the electrode assembly 10 and the non-aqueous electrolyte are accommodated into the battery case 20. Thereafter, the sealing plate 18 is placed at the opening of the battery case 20 with the gasket 19 interposed therebetween. Subsequently, the opening end of the battery case 20 is crimped toward the sealing plate 18. In such a manner, the battery 1 is obtained.

Examples of the positive electrode lead 14 include an aluminum lead. Examples of the negative electrode lead 15 include a nickel lead and a copper lead. The upper insulating plate 16, the lower insulating plate 17, and the gasket 19 may be the one produced by forming an insulating material such as a resin material or a rubber material into a predetermined shape. The sealing plate 18 and the battery case 20 may be the one produced by forming a metal material such as iron or stainless steel into a predetermined shape.

The electrode assembly 10 includes the positive electrode 11, the negative electrode 12, and the separator 13.

The positive electrode 11 includes a positive electrode current collector and a positive electrode active material layer formed on each of both surfaces of the positive electrode current collector. The positive electrode current collector may be a metal foil made of a metal material such as aluminum, an aluminum alloy, titanium, or stainless steel. The thickness of the positive electrode current collector is not particularly limited, but is preferably 5 μm to 50 μm.

The positive electrode active material layer is formed on both surfaces of the positive electrode current collector in this embodiment, but may be formed on either one surface thereof. The positive electrode active material layer includes the positive electrode active material of this embodiment, a conductive agent, and a binder. The positive electrode active material layer can be formed by applying a positive electrode material mixture slurry onto a surface of the positive electrode current collector, and drying and rolling the resultant applied film. The positive electrode material mixture slurry can be prepared by mixing the positive electrode active material of this embodiment, a conductive agent, and a binder, with a solvent.

The positive electrode active material of this embodiment may include, together with the lithium composite oxide of this embodiment, various positive electrode active materials commonly used in the field of lithium ion secondary batteries in an amount within a range that does not impair favorable properties of the lithium composite oxide of this embodiment.

Examples of the conductive agent include carbon blacks, such as acetylene black and Ketjen black; and graphites, such as natural graphite and artificial graphite. Examples of the binder include resin materials, such as polytetrafluoroethylene, polyvinylidene fluoride, and polyacrylic acid; and rubber materials, such as styrene-butadiene rubber containing acrylic acid monomer (trade name: BM-500B, available from Zeon Corporation, Japan) and styrene-butadiene rubber (trade name: BM-400B, available from Zeon Corporation, Japan). Examples of the solvent to be mixed with the positive electrode active material of this embodiment, the conductive agent, and the binder include organic solvents, such as N-methyl-2-pyrrolidone, tetrahydrofuran, and dimethylformamide; and water. The positive electrode material mixture slurry may further include a thickener such as carboxymethyl cellulose.

The negative electrode 12 includes a negative electrode current collector and a negative electrode active material layer formed on each of both surfaces of the negative electrode current collector. The negative electrode current collector may be a metal foil made of a metal material such as copper, a copper alloy, stainless steel, or nickel. The thickness of the negative electrode current collector is not particularly limited, but is preferably 5 μm to 50 μm.

The negative electrode active material layer is formed on both surfaces of the negative electrode current collector in this embodiment, but may be formed on either one surface of the negative electrode current collector. The negative electrode active material layer can be formed by, for example, applying a negative electrode material mixture slurry onto a surface of the negative electrode current collector, and drying and rolling the resultant applied film. The negative electrode material mixture slurry can be prepared by mixing a negative electrode active material and a binder, with a solvent.

The negative electrode active material may be the one commonly used in the field of lithium ion secondary batteries, and, for example, may be a carbon material (e.g., natural graphite, artificial graphite, or hard carbon), an element capable of alloying with lithium (e.g., Al, Si, Zn, Ge, Cd, Sn, Ti, or Pb), a silicon compound (e.g., SiOₓ where 0<x<2), a tin compound (e.g., SnO), lithium metal, a lithium alloy (e.g., a Li—Al alloy), or an alloy not containing lithium (e.g., a Ni—Si alloy or Ti—Si alloy). These negative electrode active materials may be used singly or in combination of two or more.

The binder may be the same binder as used in the positive electrode material mixture slurry, and the solvent to be mixed with the negative electrode active material may be the same solvent as used in the positive electrode material mixture slurry.

The negative electrode material mixture slurry may further include a conductive agent, a thickener, and the like. The conductive agent may be the same conductive agent as used in the positive electrode material mixture slurry. Examples of the thickener include carboxymethyl cellulose, polyethylene oxide, and modified polyacrylonitrile rubbers.

It should be noted that when the negative electrode active material is an element capable of alloying with lithium, a silicon compound, or a tin compound, the negative electrode active material layer may be formed by a vapor phase method such as chemical vapor deposition, vacuum vapor deposition, or sputtering.

Examples of the separator 13 include porous sheets having pores, non-woven fabrics of resin fibers, and woven fabrics of resin fibers. Among these, preferred is a porous sheet, and more preferred is a porous sheet having pores of about 0.05 μm to 0.15 μm in diameter. Such a porous sheet has high levels of ion permeability, mechanical strength, and insulating property. The thickness of the porous sheet is not particularly limited, but is, for example, 5 μm to 30 μm. The porous sheet and resin fibers are made of a resin material. Examples of the resin material include polyolefins, such as polyethylene and polypropylene; polyamides; and polyamide-imides.

The non-aqueous electrolyte to be mainly impregnated into the electrode assembly 10 includes a lithium salt and a non-aqueous solvent. Examples of the lithium salt include LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lithium lower aliphatic carboxylate, LiCl, LiBr, LiI, LiBCl₄, borates, and imides. These lithium salts may be used singly or in combination of two or more. The concentration of the lithium salt in 1 liter of the non-aqueous solvent is preferably 0.5 mol to 2 mol.

Examples of the non-aqueous solvent include cyclic carbonic acid esters, chain carbonic acid esters, and cyclic carboxylic acid esters. Examples of the cyclic carbonic acid esters include propylene carbonate and ethylene carbonate. Examples of the chain carbonic acid esters include diethyl carbonate, ethyl methyl carbonate, and dimethyl carbonate. Examples of the chain carbonic acid esters include γ-butyrolactone and γ-valerolactone. These non-aqueous solvents may be used singly or in combination of two or more.

The non-aqueous electrolyte may further include an additive. Examples of the additive include VC compounds and benzene compounds. Examples of the VC compounds include vinylene carbonate, vinyl ethylene carbonate, and divinylethylene carbonate. The VC compounds may contain fluorine atoms. Examples of the benzene compounds include cyclohexylbenzene, biphenyl, and diphenyl ether.

Description about a cylindrical battery including a wound electrode assembly is given in this embodiment, but the lithium ion secondary battery of the present invention is not limited thereto, and may be fabricated in the form of, for example, a prismatic battery including a wound electrode assembly, a prismatic battery including a flat electrode assembly, a coin battery including a stacked electrode assembly, a pack battery including a stacked or flat electrode assembly accommodated into a battery case made of laminate film. The flat electrode assembly can be obtained by, for example, applying pressure to a wound electrode assembly to form it into a flat shape.

### EXAMPLES

The present invention is described more specifically below with reference to Examples and Comparative Examples. It should be noted, however, that the present invention is not limited in scope to these Examples.

### Example 1

### (1) Production of Positive Electrode Plate

### (1-1) Preparation of Nickel-manganese-cobalt Hydroxide (Precursor)

Into the reaction vessel 31 (inner volume of the reaction vessel 31: 100 liters) of the production apparatus 30 shown in FIG. 1, an aqueous nickel sulfate solution, an aqueous manganese sulfate solution, and an aqueous cobalt sulfate solution were fed as raw materials each in an amount of 25 liters, and uniformly mixed together by the rotation of the stirrer 37, to give an acidic aqueous solution. In the reaction vessel 31, the acidic aqueous solution was always subjected to bubbling with nitrogen gas, and the liquid temperature of the acidic aqueous solution was 40° C. Part of the acidic aqueous solution in the reaction vessel 31 was overflown from the overflow port 35, transferred via the pump 34 and retuned from the return port 36 through the pipe 33 into the reaction vessel 31, to create a flow moving through the pipe 33 toward the bottom of the reaction vessel 31.

In this state, a 5 mol aqueous sodium hydroxide solution was fed into the reaction vessel 31 at a rate of 1 liter/min, to allow coprecipitation reaction to proceed. After the aqueous sodium hydroxide solution was fed for 5 minutes, the coprecipitation reaction was allowed to proceed for further 5 minutes. As the coprecipitation reaction proceeds, a coprecipitated material gradually deposited in the collection vessel 32. Upon completion of reaction, the coprecipitated material was taken out from the collection vessel 32, washed with water and dried. In such a manner, a precursor of a nickel-manganese-cobalt hydroxide was obtained. This precursor had a volume average particle size of 8.5 μm, a tap density of 2.2 g/cm³, and a composition of (Ni_{0.5}Mn_{0.3}CO_{0.2})(OH)₂.

### (1-2) First Step

The nickel-manganese-cobalt hydroxide: (Ni_{0.5}Mn_{0.3}CO_{0.2}) (OH)₂ obtained in the above was mixed with lithium carbonate (Li₂CO₃) such that Li/(Ni+Mn+Co) (molar ratio) became 1.03. The resultant mixture was placed in a rotary kiln. After the temperature was raised to 720° C. at a temperature raising rate of 5° C./min, the mixture was further baked at a temperature of 720° C. for 5 hours while the rotary kiln was being rotated at a rate of 2 rpm/min to cause the mixture to flow.

### (1-3) Second Step

The baked material obtained in the above was placed in an alumina container. After the temperature was raised to 900° C. at a temperature raising rate of 5° C./min in a batch kiln, the baked material was re-baked at a temperature of 900° C. for 10 hours. The resultant product was crushed and passed through a 300-mesh sieve, to give a lithium composite oxide represented by the compositional formula: Li_{1.03}(Ni_{0.5}Mn_{0.3}Co_{0.2})_{0.97}O₂.

### (1-4) Formation of Positive Electrode Plate

The lithium composite oxide (the positive electrode active material) obtained in the above was mixed with acetylene black and an aqueous dispersion of polytetrafluoroethylene in a ratio of 100:2.5:7.5 by mass. Here, the mixing ratio of the aqueous dispersion of polytetrafluoroethylene is based on solid content. The resultant mixture was suspended in an aqueous carboxymethyl cellulose solution, to prepare a positive electrode material mixture slurry. This positive electrode material mixture slurry was applied onto both surfaces of a 15-μm-thick aluminum foil. The applied films were dried and rolled, and the aluminum foil with the applied films formed thereon was cut out into a predetermined size, to give a positive electrode plate having a thickness of 150 μm.

### (2) Production of Negative Electrode Plate

Pitch-based spherical graphite was mixed with an aqueous dispersion of styrene-butadiene rubber in a ratio of 100:3.5 by mass. Here, the mixing ratio of the aqueous dispersion of styrene-butadiene rubber is based on solid content. The resultant mixture was suspended in an aqueous carboxymethyl cellulose solution, to prepare a negative electrode material mixture slurry. This negative electrode material mixture slurry was applied onto both surfaces of a 10-μm-thick copper foil. The applied films were dried and rolled, and the copper foil with the applied films formed thereon was cut out into a predetermined size, to give a negative electrode plate having a thickness of 160 μm.

### (3) Preparation of Non-aqueous Electrolyte

LiPF₆ was dissolved at a concentration of 1.5 mol/L in a mixed solvent obtained by mixing ethylene carbonate and ethyl methyl carbonate in a ratio of 1:3 by volume, to prepare a non-aqueous electrolyte.

### (4) Fabrication of Battery

To the positive electrode plate and the negative electrode plate obtained in the above, one end of an aluminum lead (a positive electrode lead) and a nickel lead (a negative electrode lead) were attached, respectively, and then the positive and negative electrode plates were spirally wound with a polyethylene separator interposed therebetween, to form a wound electrode assembly. On the both ends of the wound electrode assembly in the longitudinal direction thereof, an upper insulating plate and a lower insulating plate were placed, respectively, and these were put into a battery case made of a stainless-steel plate having resistance to non-aqueous electrolyte.

The other end of the aluminum lead was laser-welded to a sealing plate, and the other end of the nickel lead was resistance-welded to the inner bottom of the battery case. Subsequently, the non-aqueous electrolyte was injected into the battery case. The sealing plate was mounted at the opening of the battery case with a gasket interposed therebetween, to seal the battery case. In such a manner, a cylindrical lithium ion secondary battery of Example 1 was fabricated. It should be noted that in this Example, a negative electrode plate with large capacity was used in order to evaluate the characteristics of the positive electrode active material.

The obtained positive electrode active material and battery were evaluated in the manner as described below.

### [Powder X-ray Diffractometry]

With respect to the baked material obtained in the first step and the positive electrode active material obtained in the second step, powder X-ray diffraction patterns were measured at 25° C. by using CuKα radiation with a powder X-ray diffractometer (trade name: D8-ADVANCE, available from Bruker Corporation). An angle of diffraction peak corresponding to the (104) plane within the range 2θ=44° to 45° (hereinafter referred to as a “(104) 2θ angle”) in each powder X-ray diffraction pattern was determined. The synthesis conditions, the (104) 2θ angle, and the Δ2θ of the baked material obtained in the first step and the positive electrode active material obtained in the second step are shown in Table 1.

### [Measurement of Capacity Retention Rate]

The obtained battery was subjected to three charge/discharge cycles, each cycle consisting of a constant-current charge and a subsequent constant-current discharge performed under the conditions described below, at an environment temperature of 20° C., and the discharge capacity at the 3rd cycle was determined as an initial capacity. The initial capacity was divided by the weight of the positive electrode active material included in the positive electrode of the battery, to calculate a specific capacity (mAh/g) of the active material. The results are shown in Table 2.

Constant-current charge: Current value 120 mA, charge cut-off voltage 4.2 V, interval between charge and discharge 1 hour

Constant-current discharge: Current value 135 mA, discharge cut-off voltage 3.0 V

Thereafter, each battery was subjected to three hundred charge/discharge cycles, each cycle consisting of a constant-current charge and a subsequent constant-current discharge performed under the conditions described below, at an environment temperature of 20° C., and the discharge capacity at the 300th was measured. The percentage of the 300th discharge capacity relative to the initial capacity was determined as a capacity retention rate (%). The results are shown in Table 2.

Constant-current charge: Current value 135 mA, charge cut-off voltage 4.2 V, interval between charge and discharge 1 hour

Constant-current discharge: Current value 135 mA, discharge cut-off voltage 3.0 V

### Example 2

A positive electrode active material was prepared in the same manner as in Example 1, except that in the process of producing a positive electrode plate, the baking temperature in the first step was changed from 720° C. to 750° C. A cylindrical lithium ion secondary battery was fabricated in the same manner as in Example 1, except that this positive electrode active material was used. The obtained positive electrode active material and battery were subjected to the evaluation in the same manner as in Example 1. The results are shown in Tables 1 and 2.

### Example 3

A positive electrode active material was prepared in the same manner as in Example 1, except that in the process of producing a positive electrode plate, the baking temperature in the first step was changed from 720° C. to 800° C., and the baking temperature in the second step was changed from 900° C. to 850° C. A cylindrical lithium ion secondary battery was fabricated in the same manner as in Example 1, except that this positive electrode active material was used. The obtained positive electrode active material and battery were subjected to the evaluation in the same manner as in Example 1. The results are shown in Tables 1 and 2.

### Example 4

A positive electrode active material was prepared in the same manner as in Example 1, except that in the process of producing a positive electrode plate, the baking temperature in the first step was changed from 720° C. to 800° C. A cylindrical lithium ion secondary battery was fabricated in the same manner as in Example 1, except that this positive electrode active material was used. The obtained positive electrode active material and battery were subjected to the evaluation in the same manner as in Example 1. The results are shown in Tables 1 and 2.

### Example 5

A positive electrode active material was prepared in the same manner as in Example 1, except that in the process of producing a positive electrode plate, the baking temperature in the first step was changed from 720° C. to 850° C. A cylindrical lithium ion secondary battery was fabricated in the same manner as in Example 1, except that this positive electrode active material was used. The obtained positive electrode active material and battery were subjected to the evaluation in the same manner as in Example 1. The results are shown in Tables 1 and 2.

### Example 6

A positive electrode active material was prepared in the same manner as in Example 1, except that in the process of producing a positive electrode plate, the baking temperature in the first step was changed from 720° C. to 900° C. A cylindrical lithium ion secondary battery was fabricated in the same manner as in Example 1, except that this positive electrode active material was used. The obtained positive electrode active material and battery were subjected to the evaluation in the same manner as in Example 1. The results are shown in Tables 1 and 2.

### Example 7

A lithium composite oxide represented by the compositional formula: Li_{1.03} (Ni_{0.6}Mn_{0.2}Co_{0.2})_{0.97}O₂ was prepared in the same manner as in Example 1, except that the feeding amounts of the aqueous nickel sulfate solution, aqueous manganese sulfate solution, and aqueous cobalt sulfate solution were changed such that a precursor in which Ni:Mn:Co=0.6:0.2:0.2 (molar ratio) was obtained. A cylindrical lithium ion secondary battery was fabricated in the same manner as in Example 1, except that this lithium composite oxide was used as the positive electrode active material. The obtained positive electrode active material and battery were subjected to the evaluation in the same manner as in Example 1. The results are shown in Tables 1 and 2.

### Example 8

A lithium composite oxide represented by the compositional formula: Li_{1.03} (Ni_{0.8}Mn_{0.15}Co_{0.05})_{0.97}O₂ was prepared in the same manner as in Example 1, except that the feeding amounts of the aqueous nickel sulfate solution, aqueous manganese sulfate solution, and aqueous cobalt sulfate solution were changed such that a precursor in which Ni:Mn:Co=0.8:0.15:0.05 (molar ratio) was obtained. A cylindrical lithium ion secondary battery was fabricated in the same manner as in Example 1, except that this lithium composite oxide was used as the positive electrode active material. The obtained positive electrode active material and battery were subjected to the evaluation in the same manner as in Example 1. The results are shown in Tables 1 and 2.

### Example 9

A lithium composite oxide represented by the compositional formula: Li_{1.03} (Ni_{0.4}Mn_{0.3}Co_{0.3})_{0.97}O₂ was prepared in the same manner as in Example 1, except that the feeding amounts of the aqueous nickel sulfate solution, aqueous manganese sulfate solution, and aqueous cobalt sulfate solution were changed such that a precursor in which Ni:Mn:Co=0.4:0.3:0.3 (molar ratio) was obtained. A cylindrical lithium ion secondary battery was fabricated in the same manner as in Example 1, except that this lithium composite oxide was used as the positive electrode active material. The obtained positive electrode active material and battery were subjected to the evaluation in the same manner as in Example 1. The results are shown in Tables 1 and 2.

### Comparative Example 1

A positive electrode active material was prepared in the same manner as in Example 1, except that in the process of producing a positive electrode plate, the baking temperature in the first step was changed from 720° C. to 600° C. A cylindrical lithium ion secondary battery was fabricated in the same manner as in Example 1, except that this positive electrode active material was used. The obtained positive electrode active material and battery were subjected to the evaluation in the same manner as in Example 1. The results are shown in Tables 1 and 2.

### Comparative Example 2

A positive electrode active material was prepared in the same manner as in Example 1, except that in the process of producing a positive electrode plate, the baking temperature in the first step was changed from 720° C. to 700° C. A cylindrical lithium ion secondary battery was fabricated in the same manner as in Example 1, except that this positive electrode active material was used. The obtained positive electrode active material and battery were subjected to the evaluation in the same manner as in Example 1. The results are shown in Tables 1 and 2.

### Comparative Example 3

A positive electrode active material was prepared in the same manner as in Example 1, except that in the process of producing a positive electrode plate, the baking temperature in the first step was changed from 720° C. to 950° C. A cylindrical lithium ion secondary battery was fabricated in the same manner as in Example 1, except that this positive electrode active material was used. The obtained positive electrode active material and battery were subjected to the evaluation in the same manner as in Example 1. The results are shown in Tables 1 and 2.

### Comparative Example 4

A positive electrode active material was prepared in the same manner as in Example 1, except that in the process of producing a positive electrode plate, the baking temperature in the first step was changed from 720° C. to 800° C., and the baking temperature in the second step was changed from 900° C. to 950° C. A cylindrical lithium ion secondary battery was fabricated in the same manner as in Example 1, except that this positive electrode active material was used. The obtained positive electrode active material and battery were subjected to the evaluation in the same manner as in Example 1. The results are shown in Tables 1 and 2.

### Comparative Example 5

A positive electrode active material was prepared in the same manner as in Example 1, except that in the process of producing a positive electrode plate, the baking kiln used in the first step was changed from the rotary kiln to a batch kiln, and the baking temperature in the first step was changed from 720° C. to 800° C. A cylindrical lithium ion secondary battery was fabricated in the same manner as in Example 1, except that this positive electrode active material was used. The obtained positive electrode active material and battery were subjected to the evaluation in the same manner as in Example 1. The results are shown in Tables 1 and 2.

### Comparative Example 6

A positive electrode active material was prepared in the same manner as in Example 1, except that in the process of producing a positive electrode plate, the baking kiln used in the first step was changed from the rotary kiln to a batch kiln, the baking temperature in the first step was changed from 720° C. to 800° C., and the baking temperature in the second step was changed from 900° C. to 950° C. A cylindrical lithium ion secondary battery was fabricated in the same manner as in Example 1, except that this positive electrode active material was used. The obtained positive electrode active material and battery were subjected to the evaluation in the same manner as in Example 1. The results are shown in Tables 1 and 2.

TABLE 1

| | | First step | | | Second step | | | |
|---|---|---|---|---|---|---|---|---|
| | | | Baking | (104) 2θ | | Baking | (104) 2θ | |
| | | Baking | temperature | angle | Baking | temperature | angle | |
| | | kiln | (° C.) | (°) | kiln | (° C.) | (°) | Δ2θ |
| EX. | 1 | Rotary | 720 | 44.40 | Batch | 900 | 44.40 | 0.00 |
| | | kiln | | | kiln | | | |
| | 2 | Rotary | 750 | 44.41 | Batch | 900 | 44.41 | 0.00 |
| | | kiln | | | kiln | | | |
| | 3 | Rotary | 800 | 44.45 | Batch | 850 | 44.42 | −0.03 |
| | | kiln | | | kiln | | | |
| | 4 | Rotary | 800 | 44.45 | Batch | 900 | 44.45 | 0.00 |
| | | kiln | | | kiln | | | |
| | 5 | Rotary | 850 | 44.43 | Batch | 900 | 44.43 | 0.00 |
| | | kiln | | | kiln | | | |
| | 6 | Rotary | 900 | 44.40 | Batch | 900 | 44.40 | 0.00 |
| | | kiln | | | kiln | | | |
| | 7 | Rotary | 720 | 44.44 | Batch | 900 | 44.44 | 0.00 |
| | | kiln | | | kiln | | | |
| | 8 | Rotary | 720 | 44.42 | Batch | 900 | 44.42 | 0.00 |
| | | kiln | | | kiln | | | |
| | 9 | Rotary | 720 | 44.43 | Batch | 900 | 44.43 | 0.00 |
| | | kiln | | | kiln | | | |
| Com. | 1 | Rotary | 600 | 44.35 | Batch | 900 | 44.35 | 0.00 |
| Ex. | | kiln | | | kiln | | | |
| | 2 | Rotary | 700 | 44.38 | Batch | 900 | 44.38 | 0.00 |
| | | kiln | | | kiln | | | |
| | 3 | Rotary | 950 | 44.38 | Batch | 900 | 44.38 | 0.00 |
| | | kiln | | | kiln | | | |
| | 4 | Rotary | 800 | 44.45 | Batch | 950 | 44.39 | −0.06 |
| | | kiln | | | kiln | | | |
| | 5 | Batch | 800 | 44.32 | Batch | 900 | 44.32 | 0.00 |
| | | kiln | | | kiln | | | |
| | 6 | Batch | 800 | 44.32 | Batch | 950 | 44.26 | −0.06 |
| | | kiln | | | kiln | | | |

From Table 1, the (104) 2θ angles of the positive electrode active materials of Examples 1 to 9 and Comparative Examples 1 to 4 which were baked in a rotary kiln are larger than those of the positive electrode active materials of Comparative Examples 5 and 6 which were baked in a batch kiln. This is presumably because the processing in a rotary kiln, which can bake powder particles while being caused to flow in the kiln, allows the powder particles to be oxidized uniformly, resulting in the formation of a highly-crystalline positive electrode active material.

The results of the positive electrode active materials of Comparative Examples 1 to 4 indicate that the effect of the positive electrode active material is reduced when the baking temperature in a rotary kiln is below 720° C. or over 900° C. This shows that the baking temperature is preferably 720° C. to 900° C.

TABLE 2

| | | Discharge | | |
|---|---|---|---|---|
| | Initial | capacity at | Specific | Capacity |
| | capacity | 300th cycle | capacity | retention |
| | (mAh) | (mAh) | (mAh/g) | rate (%) |
| Ex. 1 | 1350 | 1229 | 160 | 91 |
| Ex. 2 | 1367 | 1258 | 162 | 92 |
| Ex. 3 | 1350 | 1188 | 160 | 88 |
| Ex. 4 | 1384 | 1315 | 164 | 95 |
| Ex. 5 | 1375 | 1279 | 163 | 93 |
| Ex. 6 | 1350 | 1215 | 160 | 90 |
| Ex. 7 | 1392 | 1239 | 165 | 89 |
| Ex. 8 | 1468 | 1291 | 174 | 88 |
| Ex. 9 | 1215 | 1118 | 144 | 92 |
| Com. Ex. 1 | 1299 | 1027 | 154 | 79 |
| Com. Ex. 2 | 1325 | 1073 | 157 | 81 |
| Com. Ex. 3 | 1325 | 1086 | 157 | 82 |
| Com. Ex. 4 | 1333 | 1040 | 158 | 78 |
| Com. Ex. 5 | 1223 | 881 | 145 | 72 |
| Com. Ex. 6 | 1181 | 721 | 140 | 61 |

From Table 2, the batteries including a positive electrode active material obtained by baking in a rotary kiln in the first step exhibit excellent charge/discharge characteristics and cycle characteristics. This is evident from the comparison between the batteries in which the baking temperatures were the same and only the baking kilns were different, specifically, the comparison between the battery of Example 4 and the battery of Comparative Example 5, and the comparison between the battery of Comparative Example 4 and the battery of Comparative Example 6.

Further, the comparison between the battery of Example 3 and the battery of Comparative Example 4 indicates that when the difference Δ2θ between the (104) 2θ angles of the baked material obtained in the first step and the positive electrode active material obtained in the second step was large, the cycle characteristics are deteriorated due to the occurrence of distortion in the crystal.

The comparison between the batteries of Examples 1 to 9 and the batteries of Comparative Examples 1 to 3 indicates that when the baking temperature in a rotary kiln was below 720° C. or over 900° C., the effect of the positive electrode active material is impaired, and thus the charge/discharge characteristics and the cycle characteristics are deteriorated.

As shown in the above, according to the present invention, it is possible to provide a lithium ion secondary battery having excellent charge/discharge characteristics and cycle characteristics, by using as a positive electrode active material, a lithium composite oxide being a layered lithium composite compound having a hexagonal crystal structure, and exhibiting a powder X-ray diffraction pattern obtained by using CuKα radiation at 25° C. in which the (104) 2θ angle is 44.4° or more.

In addition, it is possible to efficiently produce the lithium composite oxide of the present invention while suppressing the crystal distortion and oxygen deficiency which may occur in the synthesis process, by employing a production method including a first step of baking a mixture of a nickel-manganese-cobalt compound mixed with lithium carbonate or lithium hydroxide while causing the mixture to flow, and a second step of re-baking the baked material obtained in the first step.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

The positive electrode active material of the present invention can be suitably used as a positive electrode active material for a lithium ion secondary battery. The production method of a positive electrode active material of the present invention can be suitably used in industrially mass-producing the positive electrode active material of the present invention. The lithium ion secondary battery of the present invention can be used for the same application as those for the conventional lithium ion secondary batteries, and is particularly useful as a main power source or an auxiliary power source for, for example, electronic equipment, electric equipment, machining equipment, transportation equipment, and power storage equipment. Examples of the electronic equipment include personal computers, cellular phones, mobile devices, personal digital assistants, and portable game machines. Examples of the electric equipment include vacuum cleaners and video cameras. Examples of the machining equipment include electric tools and robots. Examples of the transportation equipment include electric vehicles, hybrid electric vehicles, plug-in HEVs, and fuel cell-powered vehicles. Examples of the power storage equipment include uninterrupted power supplies.

1. A positive electrode active material for a lithium ion secondary battery, comprising lithium composite oxide particles containing nickel, manganese and cobalt, the lithium composite oxide particles being a layered compound having a hexagonal crystal structure, and exhibiting a powder X-ray diffraction pattern obtained by using CuKα radiation at 25° C. in which a maximum peak within a range of 2θ=44° to 45° is present at 2θ=44.4° to 45°.

2. The positive electrode active material for a lithium ion secondary battery in accordance with claim 1, wherein the peak is present at 44.40° to 44.45°.

3. The positive electrode active material for a lithium ion secondary battery in accordance with claim 1, wherein the lithium composite oxide particles have a composition represented by the general formula (I):
Li₁₊ₓ(Ni_{1-y-z}Mn_{y}CO_{z})₁₋ₓO₂ (I)
where x, y and z satisfy −0.05≦x≦0.10, 0.15≦y≦0.3, 0.05≦z≦0.3, and 0.2≦y+z≦0.6.

4. A lithium ion secondary battery comprising: a positive electrode including a positive electrode active material capable of absorbing and desorbing lithium ions; a negative electrode including a negative electrode active material capable of absorbing and desorbing lithium ions; a separator interposed between the positive electrode and the negative electrode; and a non-aqueous electrolyte,
wherein the positive electrode active material in an uncharged state comprises lithium composite oxide particles containing nickel, manganese and cobalt, the lithium composite oxide particles being a layered compound having a hexagonal crystal structure, and exhibiting a powder X-ray diffraction pattern obtained by using CuKα radiation at 25° C. in which a maximum peak within a range of 2θ=44° to 45° is present at 2θ=44.4° to 45°.

5. The lithium ion secondary battery in accordance with claim 4, wherein the peak is present at 44.40° to 44.45°.

6. The lithium ion secondary battery in accordance with claim 4, wherein the positive electrode active material in an uncharged state has a composition represented by the general formula (I):
Li₁₊ₓ(Ni_{1-y-z}Mn_{y}CO_{z})₁₋ₓO₂ (I)
where x, y and z satisfy −0.05≦x≦0.10, 0.15≦y≦0.3, 0.05≦z≦0.3, and 0.2≦y+z≦0.6.

7. A method for producing a positive electrode active material for a lithium ion secondary battery, the method comprising:
a first step of baking particles of a mixture while being caused to flow, at a temperature within a range of 720° C. to 900° C., the mixture comprising lithium carbonate or lithium hydroxide, and a nickel-manganese-cobalt compound having a composition represented by the general formula (II):
(Ni_{1-y-z}Mn_{y}CO_{z}) (OH)₂ (II)
where y and z satisfy 0.15≦y≦0.3, 0.05≦z≦0.3, 0.2≦y+z≦0.6; and
a second step of further baking a baked material obtained in the first step at a temperature within a range of 750° C. to 1000° C.

8. The method for producing a positive electrode active material for a lithium ion secondary battery in accordance with claim 7, wherein the baking in the first step is performed in a rotary kiln.

9. The method for producing a positive electrode active material for a lithium ion secondary battery in accordance with claim 7, wherein a difference Δ2θ between an angle of a maximum peak within a range of 2θ=44° to 45° in a powder X-ray diffraction pattern obtained by using CuKα radiation at 25° C. of the baked material obtained in the first step and an angle of a maximum peak within a range of 2θ=44° to 45° in a powder X-ray diffraction pattern obtained by using CuKα radiation at 25° C. of a baked material obtained in the second step is Δ2θ≦0.03.
